(19) United States
(12) Patent Application Publication
(10) Pub. No.: US 2020/0266589 A1
(43) Pub. Date: Aug. 20, 2020

(54) CONNECTOR-INTEGRATED GROUNDING SYSTEMS AND METHODS

(71) Applicant: Autoliv ASP, Inc., Ogden, UT (US)

(72) Inventors: David Alan Storey, Syracuse, UT (US); Scott Carl Gordon, Layton, UT (US)

(73) Assignee: Autoliv ASP, Inc., Ogden, UT (US)

(21) Appl. No.: 16/276,265

(22) Filed: Feb. 14, 2019

(51) Int. Cl. H01R 24/30; B60R 21/017; H01R 24/22; H01R 13/24

(52) U.S. Cl. CPC H01R 24/30; B60R 21/017; B60R 2021/01156; H01R 13/2442; H01R 24/22

(57) ABSTRACT

A grounding system for an automotive protective system inflator is provided for protecting the inflator from inadvertent discharge and operation of the automotive protective system, such as, e.g., an airbag system. The grounding system can include an electrical connector configured to couple the inflator to an electrical harness of a vehicle. The electrical connector can include a ground path and a biased member coupled to a ground wire. The ground wire may be coupled to a ground path of the vehicle so as to draw an inadvertent electrical charge away from the inflator to the vehicle electrical harness.

### TECHNICAL FIELD

The present disclosure relates generally to the field of automotive protective systems including airbag systems that are configured to deploy in response to collision events. More specifically, the present disclosure relates to an electrical connector for an airbag inflator of an airbag system.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 is a perspective view of a steering wheel assembly with an inflatable airbag assembly including an electrical connector, according to an embodiment of the present disclosure.

FIG. 2 is a perspective view of an electrical connector, according to an embodiment of the present disclosure.

FIG. 3A is a side view of an inflator and the electrical connector of FIG. 2.

FIG. 3B is another side view of the inflator and electrical connector of FIGS. 2 and 3A, wherein the electrical connector is coupled to the inflator.

FIG. 4 is a side view of an inflator and an electrical connector, according to another embodiment of the present disclosure.

FIG. 5A is a side view of an electrical connector and a portion of an inflator, according to an embodiment of the present disclosure.

FIG. 5B is a side view of the electrical connector of FIG. 5A with the electrical connector coupled to the inflator.

FIG. 6 is a side view of a portion of an electrical connector, according to an embodiment of the present disclosure.

FIG. 7 is a side view of a portion of an electrical connector, according to an embodiment of the present disclosure.

FIG. 8 is a side view of a portion of an electrical connector, according to an embodiment of the present disclosure.

FIG. 9 is a plan view of an electrical connector showing electrical connections of the electrical connector, according to an embodiment of the present disclosure.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

An inflatable airbag assembly may be activated based on a signal from a vehicle computing device (e.g., an electronic control unit (ECU)) as transmitted through an electrical connector coupled to an initiator of an inflator of the inflatable airbag assembly. The electrical connector may be coupled to a vehicle electrical harness.

During installation, airbags are typically disposed at an interior of a housing in a packaged state (e.g., are rolled, folded, and/or otherwise compressed) or a compact configuration and may be retained in the packaged state behind a cover. During a collision event, an inflator is triggered (e.g., actuated) and the inflator rapidly fills the airbag with inflation gas. The airbag can rapidly transition from a packaged state (e.g., a compact configuration) to a deployed state (e.g., an expanded configuration). For example, the expanding airbag can open an airbag cover (e.g., by tearing through a burst seam or opening a door-like structure) to exit the housing. The inflator may be triggered by any suitable device or system, and the triggering may be in response to and/or influenced by one or more vehicle sensors. An airbag assembly can mitigate injury to an occupant of a vehicle during a collision event by reducing the effect of impact of the occupant against structures (body-structure impact) within the vehicle (such as, e.g., a dashboard or door column).

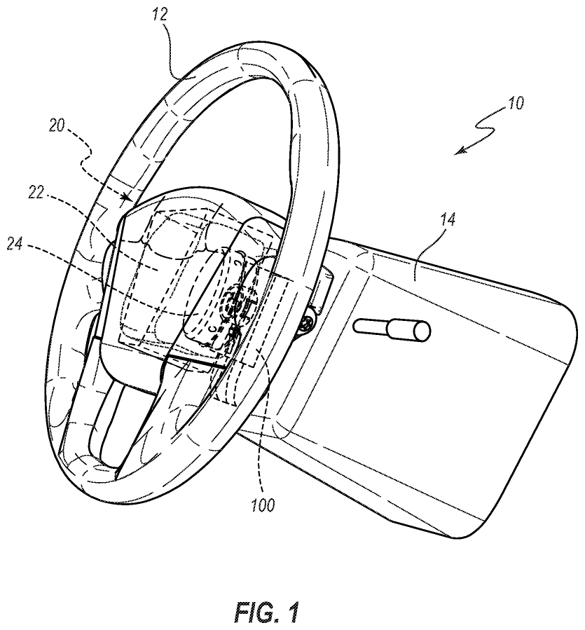

FIG. 1 is a perspective view of a steering wheel assembly 10 with an inflatable airbag assembly 20 (e.g., an automotive protective system) including an electrical connector or grounding system 100. As described herein, the grounding system can prevent or otherwise inhibit an initiator of an airbag inflator of the airbag assembly 20 from activating due to an inadvertent electrical charge, such as, e.g. an electrostatic discharge. Illustration of the inflatable airbag assembly 20 in conjunction with the steering wheel assembly 10 is for reference only. The electrical connectors provided herein may be suitable for use with a variety of safety devices, including an inflatable airbag assembly mounted to a steering wheel assembly, to an instrument panel/dashboard, to a seatback, to a roof position, as well as tether cutters, pyro safety switches, micro gas generators for seatbelt and retractor application, etc. The steering wheel assembly 10 can include a steering wheel 12 and a steering wheel column 14. The inflatable airbag assembly 20 may be coupled to the steering wheel assembly 10.

The inflatable airbag assembly 20 can include an inflatable airbag 22 and an inflator 24. In FIG. 1, the inflator 24 may be referred to as a “hamburger” inflator. The electrical connector 100 may couple the inflator 24 to at least a portion of a vehicle electrical harness. A sensor, a part of the vehicle electrical harness may be configured to detect, for example, a collision event. During a collision event, the inflator 24 may receive an electrical signal through or via the electrical connector 100 such that the inflator 24 may be triggered to generate a gas to rapidly inflate and deploy the inflatable airbag 22.

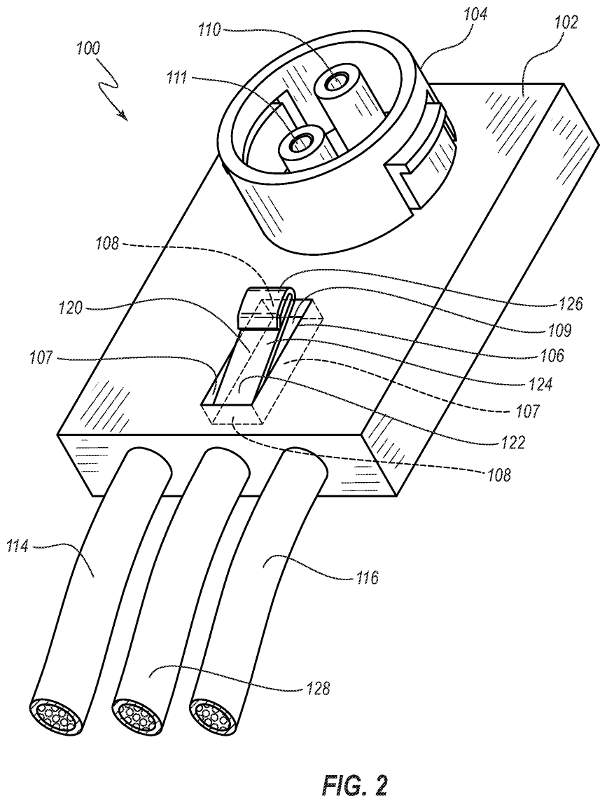

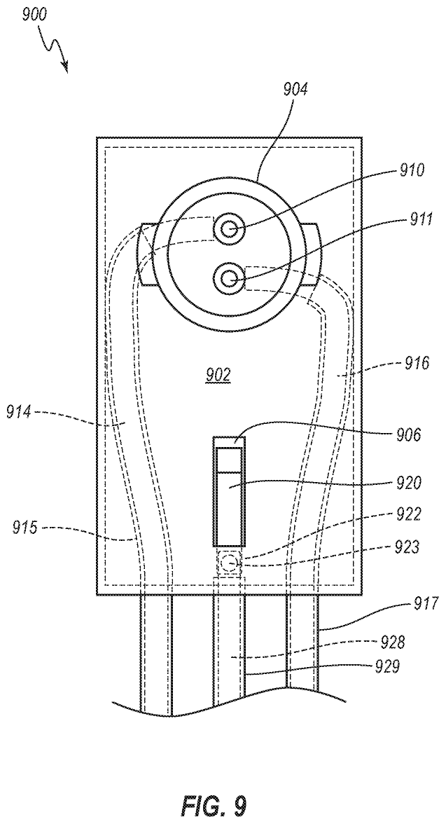

FIG. 2 is a perspective view of the electrical connector 100. The electrical connector 100 can include a housing 102, a coupler 104, a well 106, a plurality of electrical conductors 110, 111, a plurality of electrical wires 114, 116, and a biased member 120, and can include or receive a ground wire 128. The coupler 104 may be configured to couple the electrical connector 100 to an initiator of an automotive protective system. For example, the coupler 104 may couple, or be configured to couple, the electrical connector 100 to an inflator of an airbag assembly, such as the inflator 24 of FIG. 1. More particularly, the coupler 104 may secure the electrical connector 100 to an initiator of the inflator such that the electrical conductors 110, 111 electrically couple to corresponding electrical contacts of the initiator. The electrical conductors 110, 111 may be configured to mate with the electrical contacts of the initiator. The biased member 120 is configured to couple to an external surface of the inflator at a position spaced a distance from an initiator of the inflator. The external surface of the inflator may be electrically conductive. The biased member couples to the inflator to dissipate electrical charge build-up on the inflator before the electrical charge can reach the initiator. One of the electrical wires 114, 116 may be positive while another electrical wire 114, 116 may be negative. The positive electrical wire 114 or 116 may be coupled to one of the electrical conductors 110, 111, which may be a positive electrical conductor 110 or 111. The negative electrical wire 114 or 116 may likewise be coupled to the remaining electrical conductor 110, 111, which may be a negative electrical conductor 110 or 111. Coupling of the electrical wire 114, 116 to the electrical conductor 110, 111 may be accomplished by soldering, crimping, use of a butt-connector, splicing, or any other suitable method known in the art. Furthermore, the electrical wire 114, 116 may be coupled to the electrical conductor 110, 111 within the housing 102. In certain embodiments, the housing 102 may be formed from a non-conductive, or substantially non-conductive, material. In FIG. 2, the configuration of the wires 114, 128, 116 (in that physical arrangement) is by way of example only. Other configurations of the wires 114, 116, 128 are also within the scope of this disclosure. A more detailed description of an arrangement of wires 114, 116, 128 is provided in connection with FIG. 9.

The biased member 120 may further include a first end 122, an elongate portion 124, and a second end 126. The biased member 120 may be coupled to the ground wire 128, for example, within the housing 102 such that the housing 102 at least partially encloses a coupling point of the biased member 120 and the ground wire 128. The biased member 120 may couple to the ground wire 128 at the first end 122 of the biased member, as shown in FIG. 2. The coupling of the first end 122 to the ground wire 128 may be disposed proximally (toward the wires 114, 116, 128) relative to the second end 126, as shown. In other words, the second end 126 is oriented distal to the first end 122 and the second end is disposed between the coupler 104 and the first end 122. In other embodiments, the biased member 120 may be oriented differently, such that the second end 126 is disposed proximally to the coupling of the first end 122 to the ground wire 128. In still other embodiments, the first end 122 and coupling to the ground wire 128 are disposed between the second end 126 and the coupler 104. In other words, a coupling of the first end 122 to the ground wire 128 is disposed between the coupler 104 (the portion of the housing configured to couple to the portion of an inflator base of the inflator) and an opposite end (e.g., the second end 126) of the biased member 120.

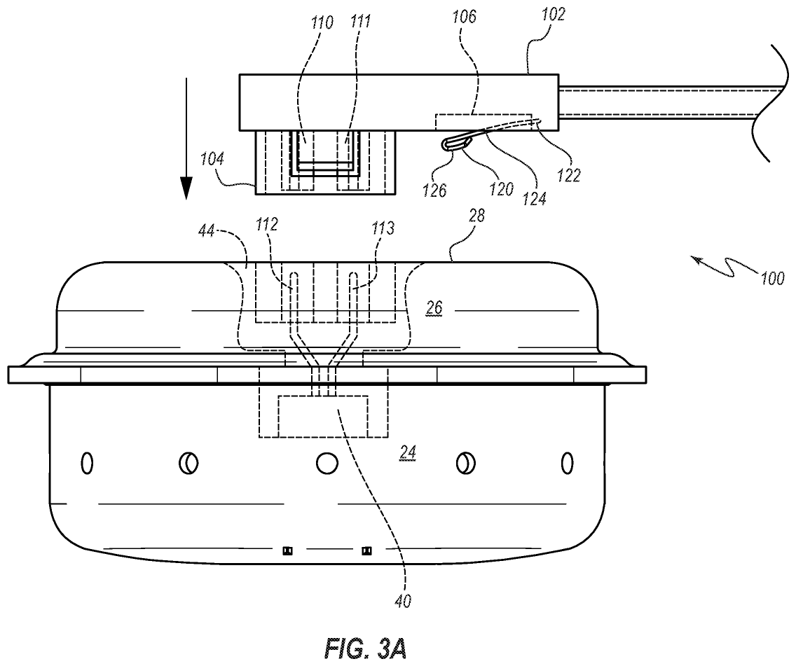

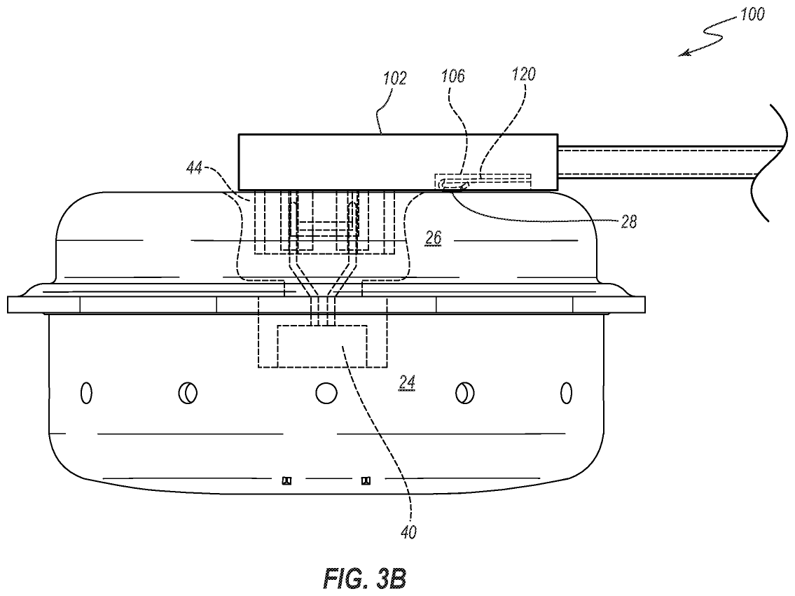

The biased member 120 may be formed from any suitable material, such as, by way of example, stainless steel (e.g., 316 stainless steel), INCONEL® 600, a copper alloy, an aluminum alloy, etc. In other words, the suitable material for forming the biased member 120 may be an electrically conductive material having properties of ductility, elasticity, and resilience to provide spring-like contact at the external surface of the inflator for the life of the electrical connector 100 In some embodiments, the biased member 120 may be formed from a material having a nominally low electrical impedance. A portion of the biased member 120 (e.g., the second end 126 and at least a portion of the elongate portion 124) may extend or be configured to extend outward through the well 106 of the housing 102 (e.g., to an exterior of the housing 102), such as by a bend or curve, or any other suitable manner, provided that at least a portion of the biased member 120 extends beyond an outer surface of the housing 102. The bend or curve may impart to the biased member 120 a spring loading whereby the biased member 120 may at least partially resist being disposed, pushed, forced, retracted, or otherwise deflected from its original disposition. Furthermore, the curved shape of the biased member 120 may cause or result in the biased member 120 coupling, or being coupled, to at least a portion of an inflator base (see FIG. 3A). The biased member 120 may be configured to electrically couple to an electrically conductive external surface of an inflator at a position spaced a distance from an initiator of the inflator.

FIG. 3A is a side view of the inflator 24 and the electrical connector 100. The inflator 24 can include an inflator base 26 and an initiator 40. The initiator 40 can include a plurality of electrical contacts 112, 113. The electrical contacts 112, 113, in one embodiment, may be pins configured to mate with the electrical conductors 110, 111. The initiator 40 may be installed or otherwise disposed such that the initiator 40 is electrically isolated or insulated from the inflator base 26, for example, by an insulator 44. The coupler 104 of the electrical connector 100 is illustrated near the inflator base 26 with the electrical conductors 110, 111 aligned with the plurality of electrical contacts 112, 113 of the inflator 24.

As discussed above, the biased member 120 may include the first end 122, the second end 126, and the elongate portion 124 extending between the first and second ends 122, 126. At least a portion of the biased member 120 may extend from or out of the well 106 of the housing 102 and be configured to make contact with at least an electrically conductive portion of the inflator base 26 when the electrical connector 100 is coupled to the inflator 24. Accordingly, the biased member 120 may be configured to conduct an electrical charge away from the inflator base 26 to the ground wire 128. In FIG. 3A, the biased member 120 is shown having a slight concave curve (e.g., a curved shape) beginning at the first end 122 and continuing through the elongate portion 124 to the second end 126. The illustrated curve of the biased member 120 is by way of example only. In another embodiment, the curve of the biased member 120 may be of a greater or lesser radius. In yet another embodiment, the biased member 120 may have a bend near or at the first end 122 whereby a portion of the elongate portion 124 traverses the well 106 such that the second end 126 extends outside the well 106. In another embodiment, the biased member 120 may be straight, and may couple to the housing 102 at an angle relative to an outside surface of the housing 102. The first end 122 may be enclosed within the housing 102 and the elongate portion 124 may traverse the well 106 such that the second end 126 is disposed external to an outside surface of the housing 102. Other configurations of the biased member 120 are also within the scope of this disclosure.

With reference to FIG. 2, the well 106 may include one or more lateral walls 107, one or more longitudinal walls 108, and a lower wall 109. While FIG. 2 illustrates the lateral walls 107 and longitudinal walls 108 disposed at a perimeter of the well 106, any of the walls 107, 108 may be disposed adjacent to, near, or somewhat distal to a perimeter of the well 106. In certain embodiments, the walls 107, 108 may electrically isolate the biased member 120 from other components of, or within, the housing 102. In another embodiment, the well 106 may take the form of an aperture absent the lateral and longitudinal walls 107, 108. The lower wall 109 may provide a surface against which a portion of the biased member 120 may rest or push when the electrical connector 100 is coupled to an inflator base (see, e.g., FIG. 3B). In some embodiments, the lower wall 109 or a portion of the lower wall 109 may be absent.

The first end 122 of the biased member 120 may be rigidly coupled to the housing 102. More particularly, the first end 122 may be affixed to or through one of the longitudinal walls 108, or the lower wall 109, so as to dispose and support the second end 126 as described elsewhere in this disclosure.

FIG. 3B is a side view of the inflator 24 and the electrical connector 100 of FIG. 3A, wherein the electrical connector 100 is coupled to or engaged with the inflator 24. With reference to FIGS. 3A and 3B, the electrical connector 100 may be coupled, or configured to be coupled, to the inflator 24 at or adjacent to the inflator base 26. For example, the coupler 104 may be physically coupled to the inflator base 26 such that each electrical conductor 110, 111 of the electrical connector 100 makes contact (e.g., suitable for conducting electricity) with the electrical contacts 112, 113 of the inflator 24. With the electrical connector 100 coupled at the inflator base 26, at least a portion of the biased member 120 may contact at least a portion of the inflator base 26. The contact between the biased member 120 and the inflator base 26 can occur at or near a position 28. The inflator base 26 may partially push, retract, or otherwise dispose the biased member 120 at least partially into the housing 102 and/or the well 106. The spring loading of the biased member 120 may ensure the biased member 120 remains in constant, or substantially constant, contact with the inflator base 26. In some embodiments, the well 106 of the housing 102 may be configured to prevent the biased member 120 from being pushed into the well 106 so far as to reduce or eliminate the contact at position 28 between the biased member 120 and the inflator base 26.

The inflator base 26 may be formed of an electrically conductive material. The contact between the inflator base 26 and the biased member 120 may provide a ground path, for example, via the ground wire 128, to prevent, draw off, or reduce an accumulation of electricity (e.g., static electricity) at an inflatable airbag assembly (see, e.g., the inflatable airbag assembly 20 of FIG. 1), and more particularly, at the inflator 24. Preventing or reducing a build-up of electricity at the inflator 24 may prevent or otherwise protect the inflator 24 from being inadvertently or accidentally triggered and causing an inflatable airbag to deploy in a non-collision situation, such as during normal operation of the vehicle.

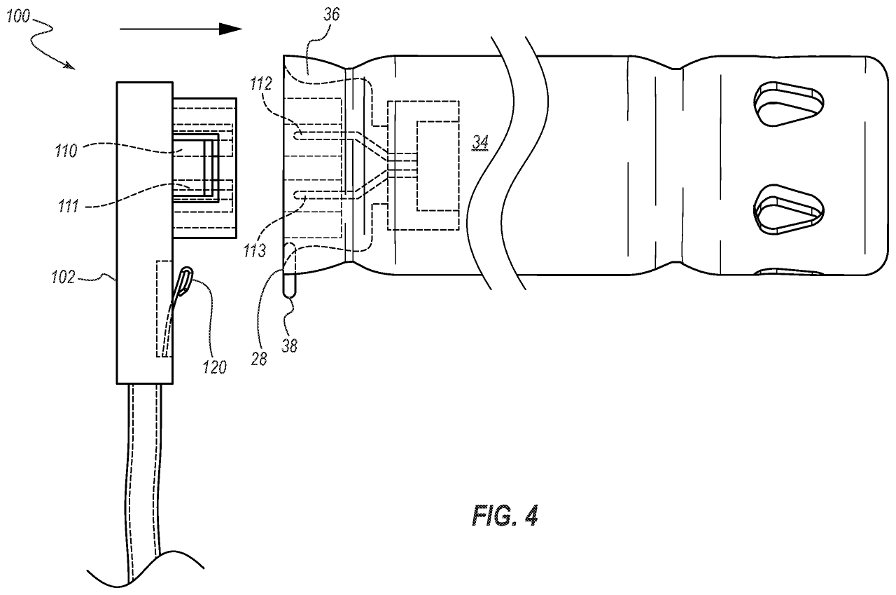

FIG. 4 is a side view of another embodiment of an inflator 34 and the electrical connector 100. The housing 102, electrical conductors 110, 111, and the biased member 120 of the electrical connector 100 are shown for reference, as are the electrical contacts 112, 113 of the inflator 34. The inflator 34 can include an inflator base 36. The inflator base 36, according to some embodiments, may be formed from an electrically conductive material. The electrical connector 100 may be configured to dispose the biased member 120 so as to contact the inflator base 36 at a position 28 (e.g., separated a distance from the electrical contacts 112, 113 of the initiator) when the electrical connector 100 is coupled to the inflator 34. In some embodiments, the inflator base 36 may include a tab 38 configured to contact the biased member 120 when the electrical connector 100 is coupled to the inflator base 36. The contact between the inflator base 36 and the biased member 120 at position 28 may prevent, draw off, or reduce a build-up of static electricity, in particular, at the inflator 34, which, in turn, may prevent or otherwise protect the inflator 34 from accidentally inflating an inflatable airbag during normal operation of a vehicle.

While FIGS. 1-4 illustrate an electrical connector 100 in conjunction with an inflator (see, e.g., FIGS. 1-3B and 4) having a single initiator (see, e.g., FIGS. 3A and 3B), this is by way of example only, and not a limitation. The electrical connector 100 may be suitable for use with other inflators and/or airbags. For example, an electrical connector as provided herein may be suitable for use with a “smart” airbag in which an inflator may require multiple electrical connectors.

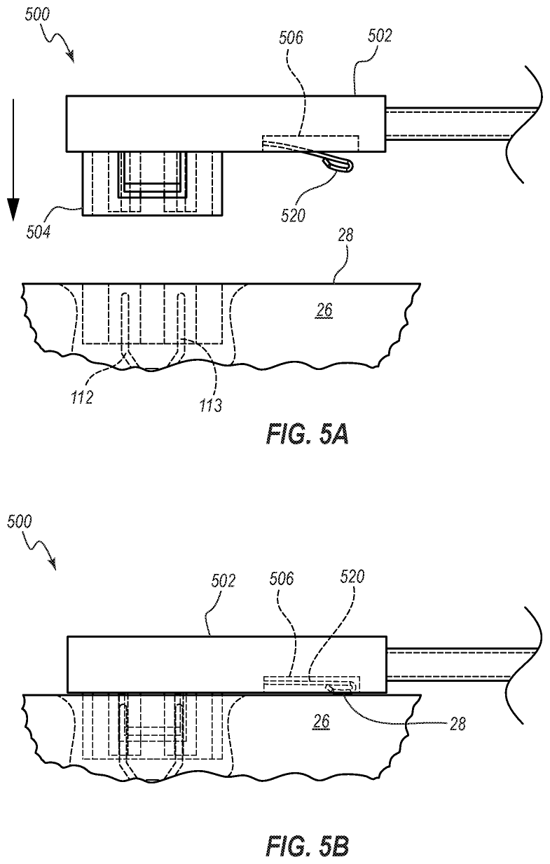

FIGS. 5A and 5B depict an embodiment of an electrical connector or grounding system 500 having some similar features to the electrical connector 100 described above in certain respects. Accordingly, like features are designated with like reference numerals, with the leading digits incremented to “5.” For example, the embodiment depicted in FIGS. 5A and 5B includes a housing 502 that may, in some respects, resemble the housing 102 of FIGS. 1-4. Relevant disclosure set forth above regarding similarly identified features thus may not be repeated hereafter. Moreover, specific features of the electrical connector 100 and related components shown in FIGS. 1-4 may not be shown or identified by a reference numeral in the drawings or specifically discussed in the written description that follows. However, any suitable combination of the features, and variations of the same, described with respect to the electrical connector 100 and related components illustrated in FIGS. 1-4 can be employed with the electrical connector 500 and related components of FIGS. 5A and 5B, and vice versa. This pattern of disclosure applies equally to further embodiments depicted in subsequent figures and described hereafter, wherein the leading digits may be further incremented.

FIG. 5A is a side view of an electrical connector 500. FIG. 5B is a partial side view of the electrical connector 500 with the electrical connector 500 coupled to the inflator base 26. A biased member 520, is shown coupled at or adjacent a well 506 of the housing 502. The orientation of the biased member 520 of the embodiment in FIGS. 5A and 5B is longitudinally reversed as compared to the biased member 120 of FIGS. 2-4. In other words, an electrical coupling of the first end of the biased member 520 may be disposed between the second end and the coupler 504. With the biased member 520 so oriented, the biased member 520 may contact the inflator base 26 at the position 28 somewhat more distal to a center of the inflator base 26. This embodiment may be more compact as it may allow more space for the electrical coupling of the ground wire and the first end of the biased member 520.

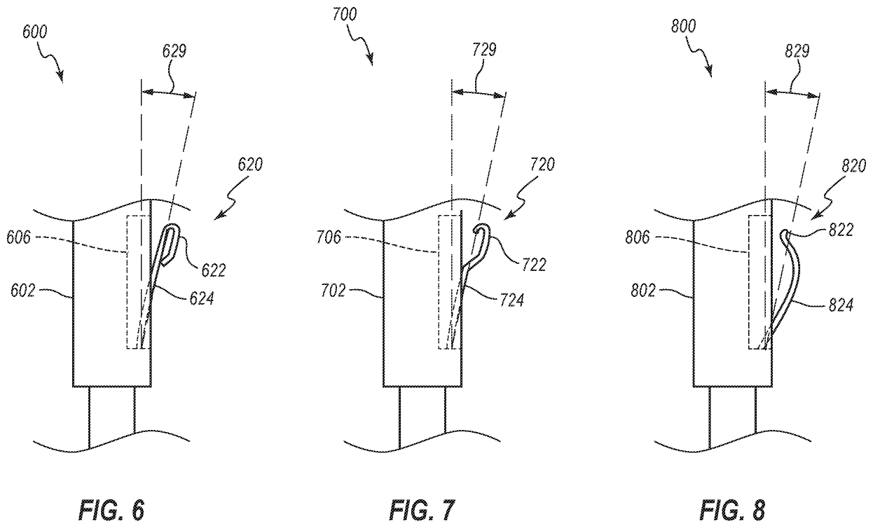

FIG. 6 is a side view of a portion of an electrical connector 600 with a biased member 620 having a concave curve. The concave curve may dispose an elongate portion 624 of the biased member to extend from an interior portion of a well 606 of a housing 602 through the well 606 such that a second end 626 of the biased member 620 is disposed external of an outer surface of the housing 602. The concave curve may also impart a spring loading to the biased member 620. The second end 626 of the biased member 620 is shown as turning back along a portion of the concave surface of the biased member 620. The concave curve may impart a nominal angle 629 of the biased member 620 relative to a longitudinal aspect of the housing 602 so as to dispose a second end 622 of the biased member 620 at a preferred position external to the well 606. The position may be selected to provide continuous contact, to reduce friction, to optimize wear, or for any other design objective. The illustrated nominal angle 629 is one example and other angles are possible.

FIG. 7 is a side view of a portion of an electrical connector 700 with a biased member 720 including an elongate portion 724 having a profile to accommodate a convex hook at a second end 726 of the biased member 720. A housing 702 and well 706 are shown for reference. The biased member 720 may have a nominal angle 729 relative to a longitudinal aspect of the housing 702 so as to dispose a second end 722 of the biased member 720 at a preferred position external to a well 706. The illustrated nominal angle 729 is by way of example and other angles are possible.

FIG. 8 is a side view of a portion of an electrical connector 800 with a biased member 820 having a convex curve. The convex curve may dispose an elongate portion 824 of the biased member 820 to protrude from a well 806 of a housing 802. The convex curve may also dispose a second end 826 of the biased member 820 to curve toward the well 806 so that, when the electrical connector 800 is coupled to an airbag inflator (not shown), the second end 826 may dispose the elongate portion 824 to remain in contact with a portion of the airbag inflator. The biased member 820 may have a nominal angle 829 relative to a longitudinal aspect of the housing 802 so as to dispose the elongate portion 824 of the biased member 820 at a preferred position external to the well 806. The illustrated nominal angle 829 is by way of example and other angles are possible.

FIGS. 6, 7, and 8 represent example embodiments of a biased member. Other embodiments of the biased member are also within the scope of this disclosure. For example, the concave curve of the elongate portion 624 of FIG. 6 may be combined with the second end 726 having the convex hook of FIG. 7. Similarly, any of the embodiments of FIGS. 6, 7, 8, and other embodiments, may be longitudinally reversed as shown in FIGS. 5A and 5B.

FIG. 9 is a plan view of an electrical connector 900 showing electrical connections of the electrical connector 900. A housing 902 and coupler 904 are shown for reference. The electrical connector 900 can include a first electrical wire 914, a second electrical wire 916, and a ground wire 928. Each of these wires 914, 916, 928 may be at least partially covered by an electrically non-conductive sheath 915, 917, 929, respectively. In the embodiment of FIG. 9, the first electrical wire 914 passes from outside the housing 902 to an interior of the housing 902 and may be coupled to a first electrical conductor 910. The second electrical wire 916 similarly passes from outside the housing 902 to the interior of the housing 902, then may be coupled to a second electrical conductor 911. Each electrical conductor 910, 911 may be disposed to couple to a corresponding electrical contact (see electrical contacts 112, 113 in FIG. 3A). The ground wire 928, similarly, passes from outside the housing 902 to an interior of the housing 902 and may be coupled, via an electrical coupling 923, to a first end 922 of a biased member 920.

The physical arrangement, from left to right, of the first electrical wire 914, the ground wire 928, and the second electrical wire 916 is an example of one embodiment. In another embodiment, the first electrical wire 914 and the ground wire 928 may be transposed. In another embodiment, the ground wire 928 and the second electrical wire 916 may be transposed. Similarly, the routing of the electrical wires 914, 916 in FIG. 9 is by way of example only, and not a limitation of the disclosure.

Throughout this specification, the phrase “coupled to” refers to any form of interaction between two or more entities, including mechanical, electrical, magnetic, electromagnetic, fluid, and thermal interaction. Two components may be coupled to each other even though they are not in direct contact with each other.

The terms “a” and “an” can be described as one, but not limited to one. For example, although the disclosure may recite an inflator having an initiator, the disclosure also contemplates that the inflator can have more than one initiator.

Unless otherwise stated, all ranges include both endpoints and all numbers between the endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 ¶6. It will be apparent to those having reasonable skill in the art that changes may be made to the details of the above-described embodiments without departing from the underlying principles of the invention. Embodiments of the invention in which an exclusive property or privilege is claimed are defined as follows.

1. A grounding system for an automotive protective system inflator, the grounding system comprising:
an electrical connector to couple an initiator of an inflator to an electrical harness of a vehicle, the electrical connector comprising:
a biased member coupled to a ground wire configured to be coupled to a ground path of the vehicle, the biased member configured to physically and electrically contact an external surface of the inflator to dissipate electrical charge build-up on the inflator before the electrical charge can reach the initiator.

2. The grounding system of claim 1, wherein the inflator comprises an inflator base and the initiator is electrically insulated from the inflator base, and
wherein the biased member is configured to couple to the inflator base at a position spaced a distance from the initiator.

3. The grounding system of claim 1, wherein the biased member is formed from a material having a nominally low electrical impedance.

4. The grounding system of claim 1, wherein the electrical connector includes a non-conductive housing.

5. The grounding system of claim 4, wherein the housing encloses at least a portion of a plurality of electrical conductors.

6. The grounding system of claim 4, wherein the biased member is coupled to the ground wire within the housing.

7. The grounding system of claim 4, wherein a portion of the housing is configured to couple to a portion of an inflator base of the inflator.

8. The grounding system of claim 7, wherein a coupling of an end of the biased member to the ground wire is disposed between the portion of the housing configured to couple to the portion of the inflator base and an opposite end of the biased member.

9. The grounding system of claim 7, wherein the at least two conductors are to couple to electrical contacts of an initiator of the inflator with the housing coupled to the inflator base.

10. The grounding system of claim 9, wherein the biased member has a curved profile such that a portion of the biased member extends out of the housing to engage a portion of the inflator base.

11. The grounding system of claim 10, wherein, with the housing coupled to the inflator base, the biased member is displaced at least partially toward the housing.

12. The grounding system of claim 1, wherein the biased member is configured to elastically deform at electrical contact to the external surface of the inflator so as to become spring-loaded to maintain the electrical contact of the biased member to the external surface of the inflator.

13. The grounding system of claim 12, wherein the biased member is configured to conduct an electrical charge away from the inflator to the ground wire.

14. An assembly for protecting an initiator of an automotive protective system from activating due to an inadvertent electrical charge, the assembly comprising:
a non-conductive housing;
a plurality of electrical conductors disposed on the non-conductive housing to couple to electrical contacts of an initiator of an automotive protective system, wherein the plurality of electrical conductors comprises a ground electrical conductor; and
a biased member coupled to a ground wire, the biased member to physically and electrically contact an exterior surface of a housing of the automotive protective system at a position spaced a distance from the contacts of the initiator, the ground wire to be coupled to a ground path of a vehicle.

15. The assembly of claim 14, wherein the non-conductive housing encloses at a least a portion of each electrical conductor of the plurality of electrical conductors.

16. The assembly of claim 14, wherein the non-conductive housing comprises an aperture through which the biased member passes from an interior of the non-conductive housing to an exterior of the non-conductive housing.

17. The assembly of claim 14, wherein the biased member is coupled to the non-conductive housing in a manner such that a portion of the biased member extends away from the non-conductive housing.

18. The assembly of claim 14, wherein the biased member has a curved shape.

19. The assembly of claim 18, wherein, with the non-conductive housing coupled to the automotive protective system, the curved shape of the biased member causes the biased member to engage a portion of the automotive protective system, and
wherein the biased member is displaced inward at least partially into the non-conductive housing when the non-conductive housing is coupled to the automotive protective system.

20. The assembly of claim 14, wherein the biased member is configured to draw an electrical charge away from the automotive protective system and to the ground wire such that the electrical charge is conducted to the ground path of the vehicle before the electrical charge can reach the initiator.

21. The assembly of claim 14, wherein the automotive protective system is an airbag system and the initiator is to initiate an airbag inflator.
